(19) United States
(12) Patent Application Publication
(10) Pub. No.: US 2017/0201456 A1
(43) Pub. Date: Jul. 13, 2017

(54) CONTROL OF TRAFFIC FROM APPLICATIONS WHEN THIRD PARTY SERVERS ENCOUNTER PROBLEMS

(71) Applicant: Intel IP Corporation, Santa Clara, CA (US)

(72) Inventors: Eric Siow, Beaverton, OR (US); Chen-Ho Chin, Deerlijk (BE); Ana Lucia A. Pinheiro, Hillsboro, OR (US); Puneet Jain, Hillsboro, OR (US); Marta Martinex Tarradell, Hillsboro, OR (US); Muthaiah Muthu Venkatachalam, Beaverton, OR (US)

(21) Appl. No.: 15/324,515

(22) PCT Filed: Jun. 16, 2015
(86) PCT No.: PCT/US2015/035937

§ 371 Date: Jan. 6, 2017

Related U.S. Application Data
(60) Provisional application No. 62/034,704, filed on Aug. 7, 2014.

(51) Int. Cl. H04L 12/801; H04W 4/00; H04W 8/18; H04L 29/08; H04L 12/26

(52) U.S. Cl. CPC H04L 47/12; H04L 67/20; H04L 43/0882; H04W 8/183; H04W 4/001; H04L 43/0817; H04L 43/16

(57) ABSTRACT

Control of Applications when Third Party Servers encounter difficulties (CATS) is discussed. An example network server that facilitates CATS comprises a processor and a transmitter circuit. The processor is configured to determine a status associated with a third party server and a network load level of a network associated with the network server, select a CATS level that defines one or more restrictions on network traffic associated with the third party server for the third party server based on the third party server status and the network load level, and implement the one or more restrictions on network traffic toward the third party server. The interface is configured to transmit an indicator of the CATS level for the third party server.

### REFERENCE TO RELATED APPLICATIONS

This application claims the benefit of U.S. Provisional Application No. 62/034,704 filed Aug. 7, 2014, entitled “METHODS TO CONTROL TRAFFIC FROM APPLICATIONS WHEN THIRD PARTY SERVERS ENCOUNTER PROBLEMS”, the contents of which are herein incorporated by reference in their entirety.

### FIELD

The present disclosure relates to controlling traffic from applications when third party servers associated with those applications encounter problems.

### BACKGROUND

With the spread of applications on user equipments (UEs), also known as “smart phones”, coupled with the rapidly growing number of UEs designed for usage with little or no human involvement (machine type communications), the potential for issues to occur in the overall “system” involving these applications, and the third party entities they interact with, increases. When these third party systems experience difficulties, they may be able to manage their problems without undue impact on operator networks, but there will be times when they are not able to do so.

When a third party server becomes congested or fails, the communication by the applications on the UEs that make use of that server need to be controlled so that excessive use of Third Generation Partnership Project (3GPP) network resources is avoided while not affecting other applications and their associated servers that are functioning normally. A third party server can be dedicated to a particular UE application or it can support multiple UE applications. When the UE or UE application fails to get to the intended third party server, it might get a HyperText Transfer Protocol (HTTP) 404 error, indicating that the requested resource could not be found but may be available again in the future. Because subsequent requests by the client are permissible, a HTTP 404 error is not sufficient, as it does not provide an indication to the application at the UE of the nature of the issue and therefore can result in frequent retries even when these will fail, thus burdening the underlying (3GPP) network with connection attempts that will fail. Third party server failure modes can also occur wherein the server is not even able to provide any HTTP status code.

The activities of the applications residing in the UEs combined with the congestion or failure of the third party servers can result in the congestion and inefficient use of resources over Radio Access Network (RAN) and Core Network (CN).

### BRIEF DESCRIPTION OF THE DRAWINGS

FIG. 1 is a block diagram of a system that can facilitate Control of Applications when Third party Servers encounter difficulties (CATS) according to various aspects described herein.

FIG. 2 is a block diagram of a system that facilitates CATS at a user equipment (UE) according to various aspects described herein.

FIG. 3 is a flow diagram of a method that can facilitate CATS at one or more nodes of a 3GPP network according to various aspects described herein.

FIG. 4 is a flow diagram of a method that facilitates CATS at a user equipment (UE) according to various aspects described herein.

FIG. 5 is an example architecture of a CATS system 500 according to various aspects described herein.

FIG. 6 is an example 3GPP network architecture for embodiments utilizing machine type communication according to various aspects described herein.

FIG. 7 is an example method of implementing CATS with prioritization based on 3GPP subscription status according to various aspects described herein.

FIG. 8 is an example method of implementing CATS with prioritization based on a subscription status with a third party server according to various with aspects described herein.

FIG. 9 is an example method of implementing CATS with prioritization based on applications or functions according to various aspects described herein.

FIG. 10 is an example method of third party implementation of CATS with prioritization based on applications or functions according to various aspects described herein.

FIG. 11 is an example implementation of NAS signaling for communication of subscription level information in connection with CATS according to various aspects described herein.

FIG. 12A is an example of an OMA-DM data structure providing information regarding a CATS policy according to various aspects described herein.

FIG. 12B is a representation of the example OMA-DM data structure of FIG. 12A as part of an OMA Management Object representation according to various aspects described herein.

FIG. 13 is an example CATS elementary file (EF), EF_{CATS}, with example contents according to various aspects described herein.

FIG. 14 is an example architecture useable for over the top signaling of CATS information, providing access to the 3GPP's PDN (Packet Data Network) Gateway through the non-3GPP access networks according to various aspects described herein.

FIG. 15 is an example method of implementing CATS via over the top signaling according to various aspects described herein.

FIG. 16 is an example method of using NAS messages to activate CATS according to various aspects described herein.

FIG. 17 is an example method of using NAS messages to deactivate CATS according to various aspects described herein.

FIG. 18 is a block diagram illustrating an example UE useable in connection with various aspects described herein.

### DETAILED DESCRIPTION

The present disclosure will now be described with reference to the attached drawing figures, wherein like reference numerals are used to refer to like elements throughout, and wherein the illustrated structures and devices are not necessarily drawn to scale. As utilized herein, terms “component,” “system,” “interface,” and the like are intended to refer to a computer-related entity, hardware, software (e.g., in execution), and/or firmware. For example, a component can be a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.”

Various embodiments described herein can provide for control of one or more applications in the event associated third party server(s) encounter problems.

In the 3GPP technical standards, the Service Exposure & Enablement Support (SEES) and Architecture Enhancements for Service Capability Exposure (AESE) define requirements for the 3GPP network and third party servers to share information.

The Feasibility Study on Application specific Congestion control for Data Communication (FS_ACDC) aims to provide potential requirements to enable certain specific applications (e.g., a Disaster Message Board) to have network access while the network is congested or otherwise disrupted due to unusual or abnormal circumstances, and therefore not able to provide normal service.

The objective of the newly introduced Feasibility Study on Control of Applications when third party Servers encounter difficulties (FS_CATS) is to enable the 3GPP network to either detect or receive indications from a third party server of its congestion or failure status so that it selectively controls individual applications on UEs when the 3GPP network becomes aware that a third party server has run into difficulties. The third party application provider can have an agreement with an operator of the 3GPP network to share information regarding the operational status and certain information regarding its subscriber/user base.

Aspects discussed herein include systems, apparatuses, machine-readable media, and methods for the 3GPP network detect and monitor the operational status of third party servers, enabling the 3GPP network to control and manage specific applications on the UEs and related traffic to reduce unnecessary congestion and inefficient use of resources in the 3GPP network. Embodiments described herein can minimize unnecessary network traffic and alleviate congestion by implementing Control of Applications when Third party Servers encounter difficulties (CATS).

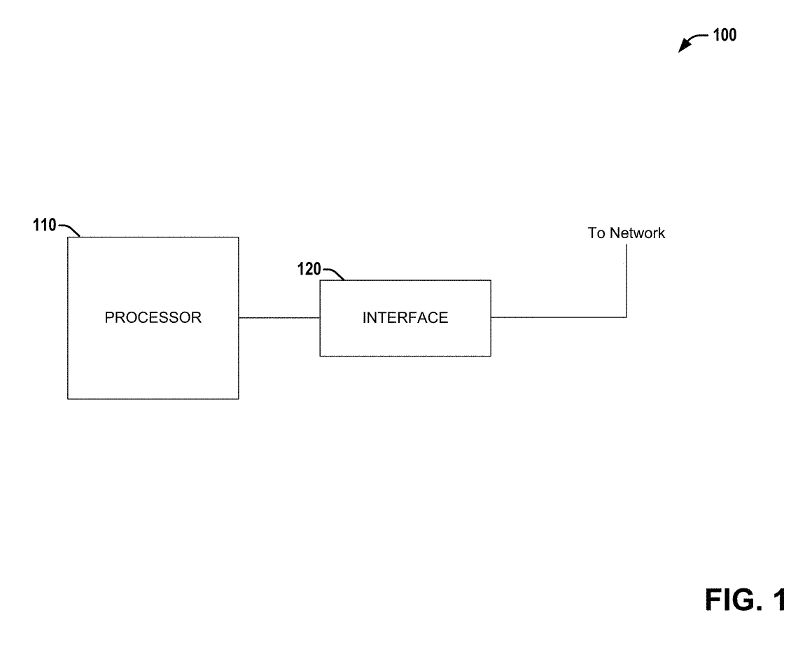

Referring to FIG. 1, illustrated is a block diagram of a system 100 that can facilitate CATS according to various aspects described herein. System 100 can include a processor 110 and an interface 120. In various aspects, system 100 or portions thereof can be included within a network server or entity within a 3GPP network, or one of a plurality of such entities can comprise system 100. In other aspects, system 100 can be collocated with one or more other entities within a 3GPP network, such as a mobile management entity (MME) or an access network discovery and selection function (ANDSF).

Processor 110 can identify when a third party server has (or no longer has) a status that affects network traffic directed to the third party server, such as excessive congestion, partial or complete failure, etc. Processor 110 can determine the status in any of a variety of ways. For example, interface 120 can optionally receive status data (e.g., via a Tsp interface, etc.) from the third party server, such as data indicating when the third party server is experiencing congestion or failure. In other aspects, interface 120 can receive status data from the third party server periodically, regardless of whether the third party server is experiencing congestion or failure. The absence of a periodic report can then also be indicative of failure. Alternatively, interface 120 can periodically send pings to the third party server, and failure or congestion can be determined by a lack of response from the third party server, or a lack of a response during a predetermined time period. In other aspects, processor 110 can determine failure or congestion of the third party server based on a lack of successful connection attempts or rejected connection attempts. For example, if no successful connection attempts occur during a predetermined period of time, processor 110 can determine that the third party server is subject to congestion/failure. Alternatively, such a determination can be made based on more than a threshold number of consecutive rejected connection attempts, or at least a threshold number of rejected connection attempts in a predetermined period of time. In further aspects, processor 110 can determine congestion/failure of the third party server based on congestion/failure information provided by the third party server to a UE connected to or attempting a connection to the third party server.

In some embodiments, based on the identified status of the third party server, processor 110 can select a level of CATS (e.g., deactivate or activate in aspects with only two levels; deactivate or activate at a selected level in other aspects) and implement the selected level of CATS. In other embodiments, processor 110 can also determine an amount of network traffic or congestion of an associated 3GPP network, and implement CATS at the selected level based on the third party server status only when a 3GPP network associated with the system 100 has at least a threshold amount of network traffic or congestion.

When CATS is activated, the selected CATS level can define one or more restrictions and/or prioritizations on network traffic directed to the third party server experiencing congestion/failure. These restrictions and/or prioritizations can, based on various criteria: prioritize network traffic, restrict new attempts at network traffic or connections, disconnect existing connections, or various combinations thereof. In various aspects, these restrictions and/or prioritizations can be implemented at one or more of the UE(s) subject to the restrictions and/or prioritizations, the system 100, or various nodes of the 3GPP network associated with system 100. In embodiments with multiple CATS levels, greater levels of congestion or failure at the third party server can be associated with higher levels of CATS, which can define more and/or stricter restrictions and/or prioritizations on network traffic directed toward the third party server.

Restrictions and/or prioritizations can be based on a variety of criteria. In various aspects, existing packet data network (PDN) connections to the third party server can be maintained, and new connections prevented, until CATS is deactivated or the CATS level is decreased. In some such aspects, if UEs that had been connected to the third party server upon CATS implementation become disconnected, new connection attempts by those UEs can be allowed, while in other such aspects, new connection attempts by those UEs can be prevented as with new connection attempts by other UEs. Additionally or alternatively, if UEs connected to the third party server become disconnected, other UEs can be allowed to connect (e.g., not to exceed the number of connected UEs or an amount of network traffic associated therewith), for example, based on prioritization discussed herein, on a first-come-first-served basis, etc. In further aspects, new connection attempts can be prioritized/restricted based on a subscription status of the UE with the 3GPP network and/or the third party server, or based on the specific application, function/service, or content type (e.g., text content to be uploaded via a social media application can prioritized over video, etc.) associated with the intended connection or network traffic between the UE and third party server. In the same or other aspects, connections can be prioritized/restricted based on the amount of network traffic associated with the connection, or an aggregate amount associated with the UE. In various embodiments, existing PDN connections can be disconnected, such as based on prioritization criteria discussed herein.

Interface 120 can transmit an indicator of the CATS level associated with the third party server. This indicator can be transmitted in a variety of ways. For example, via the non-access stratum (NAS) from the MME, via the open mobile alliance (OMA) device management (DM) protocol from the ANDSF, via HTTP from a network server comprising system 100, from a radio access network (RAN) of the associated 3GPP network (e.g., via a paging channel, multicast, broadcast, dedicated channels, etc.), etc.

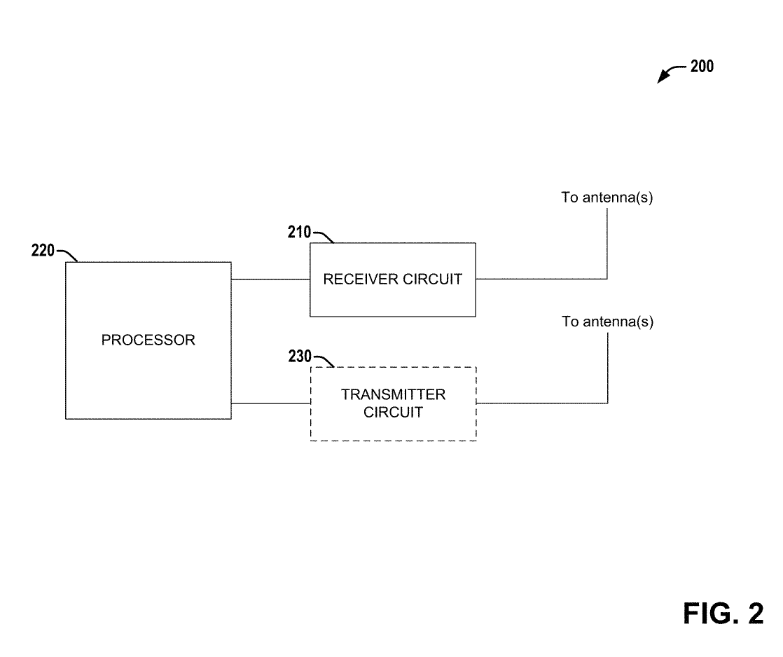

Referring to FIG. 2, illustrated is a block diagram of a system 200 that facilitates CATS at a user equipment (UE) according to various aspects described herein. System 200 includes a receiver circuit 210, a processor 220, and an optional transmitter circuit 230. Each of the receiver circuit 210 and the optional transmitter circuit 230 are configured to be coupled to one or more antennas (e.g., via antenna port(s)), which can be the same or different antenna(s). In some embodiments, the receiver circuit 210 and optional transmitter circuit 230 can have one or more components in common, and both can be included within a transceiver circuit, while in other embodiments they are not. In various aspects, system 200 can be included within a UE, for example, with system 200 (or portions thereof) within a receiver and transmitter or a transceiver circuit of a UE.

Receiver circuit 210 can receive an indication of a selected CATS level for a third party server, for example, from a RAN network (e.g., via a paging channel, broadcast, multicast, dedicated channels, etc.), from a MME via NAS, from an ANDSF via OMA-DM, from the third party server (e.g., through an application associated with the third party server) via over the top signaling, etc. As discussed supra, the CATS level can define one or more restrictions/prioritizations on network traffic toward the third party server.

Processor 220 can identify one or more applications affected by the CATS level. Depending on the restrictions/prioritizations, the identified applications can be all applications associated with the third party server or only a portion thereof (e.g., applications associated with the CATS level, applications capable of performing functions or services associated with the CATS level, etc.). Which applications are affected for a given UE can be based on any of a variety of criteria discussed herein, e.g., subscription levels with 3GPP network or third party server, etc. CATS configuration information, such as subscription-related information or other information identifying applications affected at various CATS levels (and its restrictions) are received via the receiver circuit 210. Depending on the restrictions/prioritizations, the UE comprising system 200 may be affected by the selected CATS level or not. In aspects where the UE is affected, processor 220 can, as appropriate, delay or prevent one or more transmissions associated with at least one identified application (e.g., delay until able to transmit based on prioritization, or until the CATS level is changed or CATS is deactivated, etc.).

Transmitter circuit 230, when included, can transmit data from applications as appropriate based on the CATS level. For example, transmissions associated with a first application might be restricted while those associated with a second application might not, or restrictions could depend upon the nature of the transmission of a given application (e.g., text, video, etc.).

In other aspects, system 200 can facilitate configuration of CATS at the UE. Receiver circuit 210 can receive CATS configuration information, and processor 220 can store the CATS configuration information and later identify the one or more applications affected by the CATS level based on the CATS configuration information. Multiple techniques of CATS configuration of UEs are discussed below.

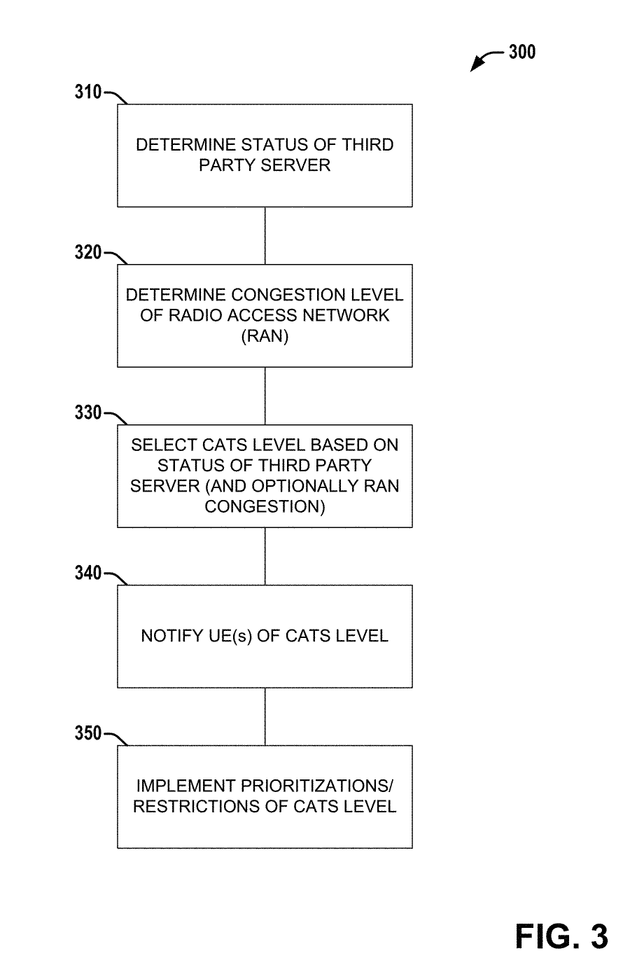

Referring to FIG. 3, illustrated is a flow diagram of a method 300 that can facilitate CATS at one or more nodes of a 3GPP network according to various aspects described herein. At 310, a congestion and/or failure status of a third party server can be determined, which can be based on status data received from the third party server, or determined by the one or more nodes of the 3GPP network. At 320, a congestion level of a radio access network (RAN) of the 3GPP network can optionally be determined. At 330, a CATS level can be selected based on the congestion/failure status of the third party server, or can be selected on such a basis only when there is at least a threshold amount of congestion in the RAN. The CATS level can define one or more restrictions and/or prioritizations on network traffic toward the third party server. At 340, one or more UEs (e.g., only affected UEs, all UEs, all UEs subscribed to a CATS service, etc.) can be notified of the CATS level selected for the third party server. At 350, the one or more prioritizations and/or restrictions of network traffic toward the third party server can be implemented. Additionally or alternatively, the one or more prioritizations and/or restrictions can be implemented by affected UEs.

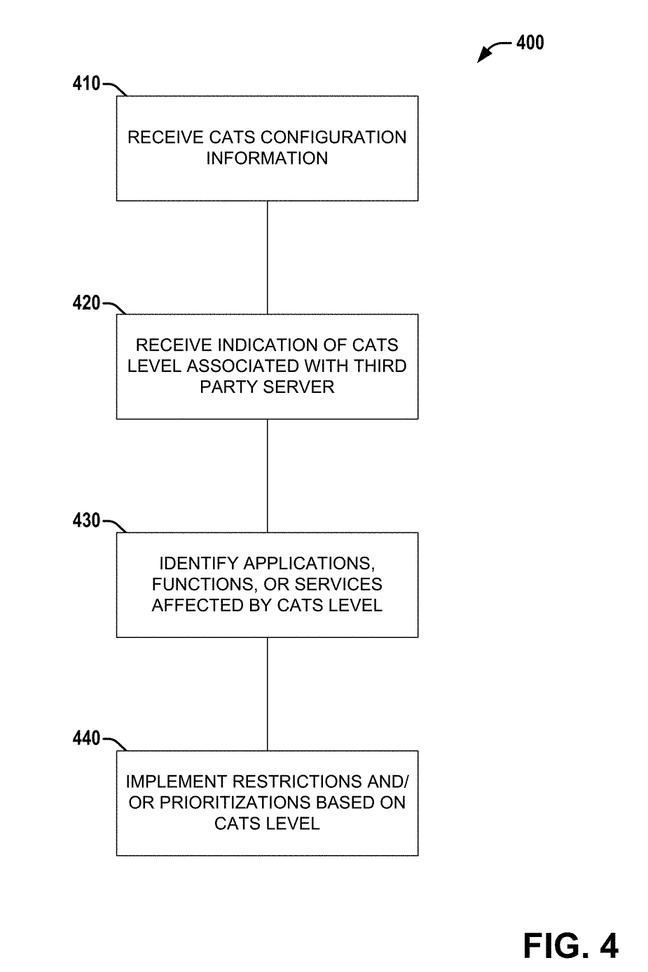

Referring to FIG. 4, illustrated is a flow diagram of a method 400 that facilitates CATS at a user equipment (UE) according to various aspects described herein. At 410, CATS configuration information can optionally be received. At 420, an indication can be received of a CATS level associated with a third party server. The CATS level can define one or more prioritizations and/or restrictions on network traffic toward the third party server. At 430, one or more applications, functions, or services associated with the third party server can be identified based on the one or more prioritizations and/or restrictions. At 440, the one or more restrictions and/or prioritizations can be implemented at the UE, delaying or preventing at least one transmission associated with at least one of the one or more applications, functions, or services.

What follows are example embodiments and various aspects of CATS systems and methods. Although specific features and examples are provided for the purposes of illustrating various aspects of embodiments discussed herein, unless otherwise indicated, these features and examples are optional, and alternative features and examples can be employed additionally or alternatively.

System Architecture for CATS (“Control of Traffic from Applications when Third Party Servers Encounter Problems”)

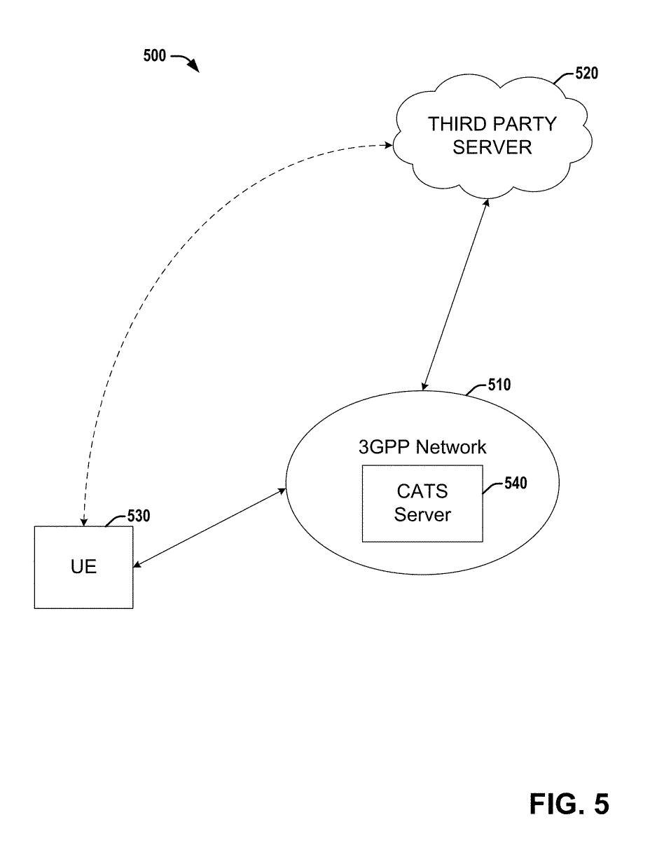

CATS functionality can involve three entities: a third party application server (third party server), the 3GPP network and the UE. Additionally, a CATS server node can be implemented as a new element or node within the 3GPP network, via an existing element or node, or as an external entity. Referring to FIG. 5, illustrated is an example architecture of a CATS system 500 according to various aspects described herein. The example architecture of the CATS system 500 can include a 3GPP network 510, a third party server 520, a UE 530, and a CATS server 540. Although 3GPP network 510 is illustrated as comprising CATS server 540 in FIG. 5, as discussed above, in alternative embodiments, CATS server 540 can be an external entity. In some embodiments, UE 530 can communicate with third party server 520 through 3GPP network 510 via 3GPP signaling, while in other embodiments, UE 530 can communicate with third party server 520 through over the top signaling (e.g., via internet protocol (IP) level signaling, etc.), as indicated by the dashed line between UE 530 and third party server 520.

In some aspects, such as shown in FIG. 5, the CATS functionality can defined within a 3GPP network entity that provisions the CATS application on the UE as well as activates/de-activates/manages the overall CATS functionality from the MNO perspective. Alternatively, there can be more than one 3GPP node responsible for the CATS functionality inside the 3GPP network, i.e., the CATS functionality may be decentralized and distributed through the 3GPP network

Additionally or alternatively, a CATS server entity can be a standalone network entity within the 3GPP network. In aspects, the CATS server entity can use SOAP/XML based transport to communicate with the UE.

Alternatively, the CATS server can be collocated with other 3GPP network entities, or its functionality can be split between different 3GPP nodes. In one example, the CATS server can be collocated with the mobile management entity (MME) and use non-access stratum (NAS) protocol to communicate with the UE. In another example, the CATS server can be collocated with the access network discovery and selection function (ANDSF) and use Open Mobile Alliance-Device Management (OMA-DM) protocol to communicate with the UE. In another example, the CATS server can be collocated with the eNB and use Radio Resource Control (RRC) protocol to communicate with the UE.

### CATS Configuration (Configuring the UE to Support CATS)

A variety of techniques can be employed to configure a UE to use CATS and with CATS configuration.

In a first example, a UE can be configured directly by the third party server (e.g., the first time it connects to it or later for reconfigurations).

In a second example, the UE can be subscribed to CATS and configuration can be modified via OMA-DM or Over-The-Air (OTA) updates.

In a third example, the network operator can configure the UE based on a UE subscription and/or information received from the third party server. Whether the UE is capable of supporting CATS can be stored as part of the subscription information in the home subscriber service (HSS)/home location register (HLR). This information can be downloaded to the MME during a subscriber data insertion procedure.

In a fourth example, the UE and the network can indicate and/or negotiate the support and configuration of CATS functionality. This procedure can involve other entities such as third party servers, a CATS server, or the HSS in order to get CATS-related information, for example, to validate the usage of CATS or to select the CATS configuration settings.

In a fifth example, the UE can be pre-configured to use CATS and a default configuration with the CATS application can be pre-configured in the UE.

Any of the example configuration techniques described above can also be applied for additional configuration beyond initial configuration, such as to modify the pre-configured information or to (de)activate the functionality.

### 3GPP Network Detection of Server Failure

When a failure occurs at a third party server, the network can detect the failure by any of a variety of techniques.

In a first example, a failure can be detected based on no successful connections being made to the third party server for at least a threshold period of time (e.g., five minutes, etc.).

In a second example, a failure can be detected based on a number of consecutive times connection requests being rejected by the third party server exceeding a threshold number (e.g., 20 attempts, etc.) or a number of connection requests in a given period of time exceeding the threshold number.

In a third example, a heartbeat ping can be employed (e.g., periodically, etc.) by the 3GPP network to detect a status of the third party server.

In a fourth example, the third party server can provide congestion (or failure, etc.) information directly to a device connected to it and a 3GPP network node (packet gateway (P-GW)/serving gateway (S-GW)/Evolved NodeB(eNB)) can extract this information via packet inspection.

In further aspects, the 3GPP Network can query the third party server for congestion/failure/etc. information based at least in part on a network implementation, defined rules, and/or when a potential failure situation is detected by the 3GPP network. In some of these aspects, additional control communication can be created to communicate such information between the network and the third party server. Alternatively, the functionality of current interfaces can be expanded to handle such information.

When the third party server is congested (or fails, etc.), information about the congestion (or failure, etc.) situation can be provided to the relevant entities so that further attempts towards the congested, etc. server can be prevented. This can involve informing both the 3GPP system and the UE about the congestion, etc.

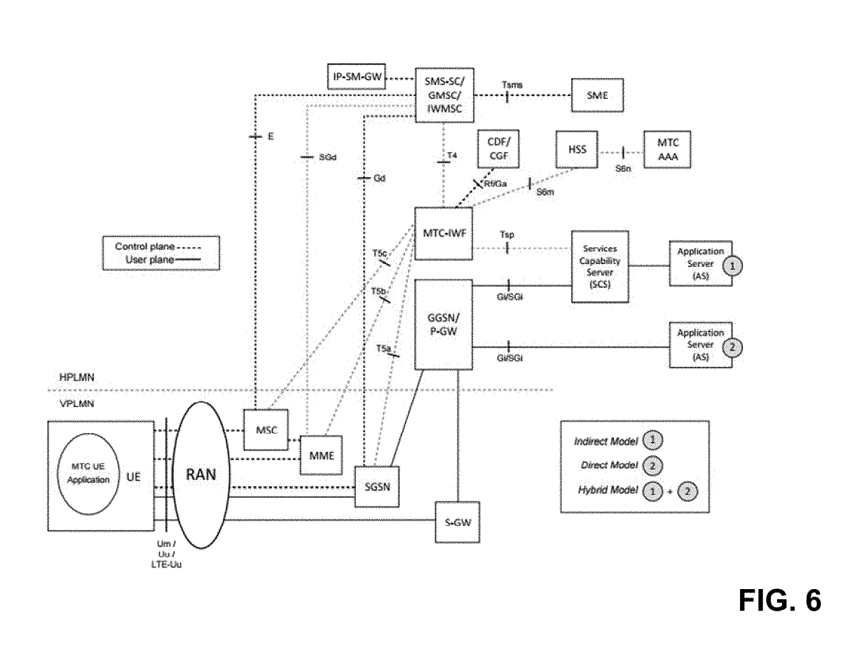

Embodiments described herein can be employed in connection with a wide range of system architectures, and the 3GPP system can be informed of congestion/failure at the third party server in a variety of ways. For example, FIG. 6 illustrates an example 3GPP network architecture for embodiments utilizing machine type communication according to various aspects described herein.

In a first example, the 3GPP system can be informed using an existing interface such as a Tsp interface. The Service Capability Server (SCS) or third party application server can send a message (e.g., indicating overload, etc.) to the Interworking Function (IWF), as seen in FIG. 6. The IWF can send this information to the Mobility Management Entity (MME) via the T5 interface. If the UE initiates a new PDN connection towards the congested, etc. server, the MME can drop the attach request or service request. This information can be passed to a target MME in case of MME relocation. In aspects, Tsp can be implemented as an Application Programming Interface (API), for example, the IWF can expose APIs towards the SCS to get third party load information.

In a second example, the IWF can send congestion, etc. information to the Packet Gateway (P-GW). The P-GW can use existing mechanisms to throttle the traffic towards the congested (etc.) third party server. The P-GW can also detect the establishment of new IP (internet protocol) flow towards the congested (etc.) third party server either directly or via the Traffic Detection Function (TDF) and reject those connections. Congestion, etc. information at P-GW can be maintained per access point name (APN) by applying existing mechanisms, or on a per application basis.

In a third example, congestion/failure/etc. information can be kept at the CATS server (e.g., in the 3GPP system, etc.). The CATS server can contain congestion/failure/etc. information for the third party servers that have business agreements with the 3GPP operator. The CATS server can then pass this information to the different 3GPP nodes and/or the UE.

Informing the UE can also occur in a variety of ways.

In a first example, the CATS server can pass the congestion, failure, etc. information directly to the UE. As explained supra, the CATS server can be collocated with the MME or ANDSF, or can be a standalone entity.

In a second example, the UE can maintain congestion, failure, etc. information on a per application basis as part of the UE context information.

Various procedures can be employed to inform the UE. In some embodiments, for IDLE mode, the UE can check the congestion, failure, etc. information before initiating a new service request/RRC (radio resource control) connection. In the same or other embodiments, for CONNECTED mode, the UE can check the congestion information before initiating new IP flow or new PDN connection to the same APN.

### Activation of CATS to Manage Access to the Third Party Server During a Partial Failure or Congestion

After detection or notification of a partial failure or congestion, the 3GPP network can either activate CATS regardless of the status of the 3GPP network, or can activate CATS if the network load of the 3GPP network exceeds a threshold. In this second set of embodiments, if the network load is below the threshold, CATS need not be activated, and UEs can continue trying to connect to the server without impacting the network.

When a third party server experiences a partial failure or congestion, it need not be necessary to disable all connections or attempts to access the third party server. The congestion can be alleviated via a variety of techniques.

In a first example, existing PDN connections with the third party server can be maintained, while preventing new attempts to connect any UE to the third party server with congestion or partial failure.

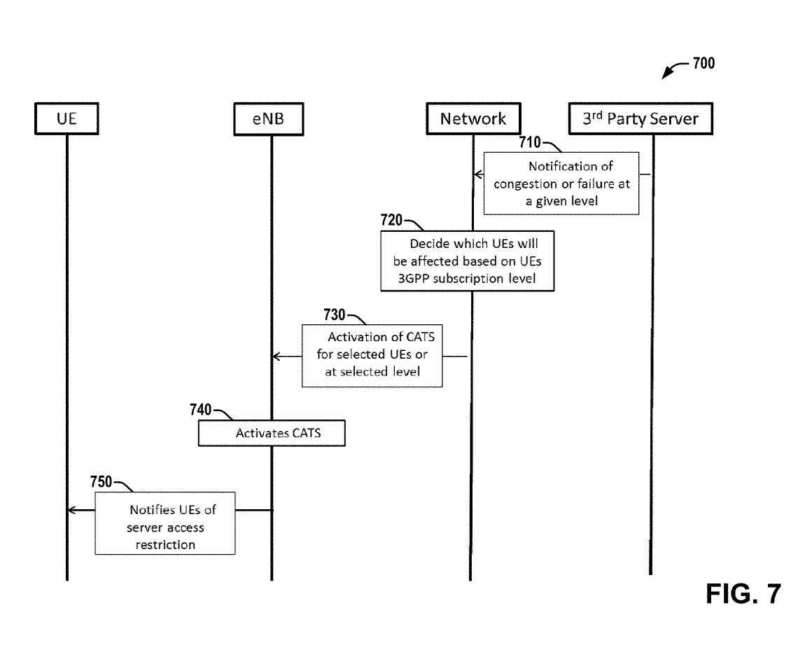

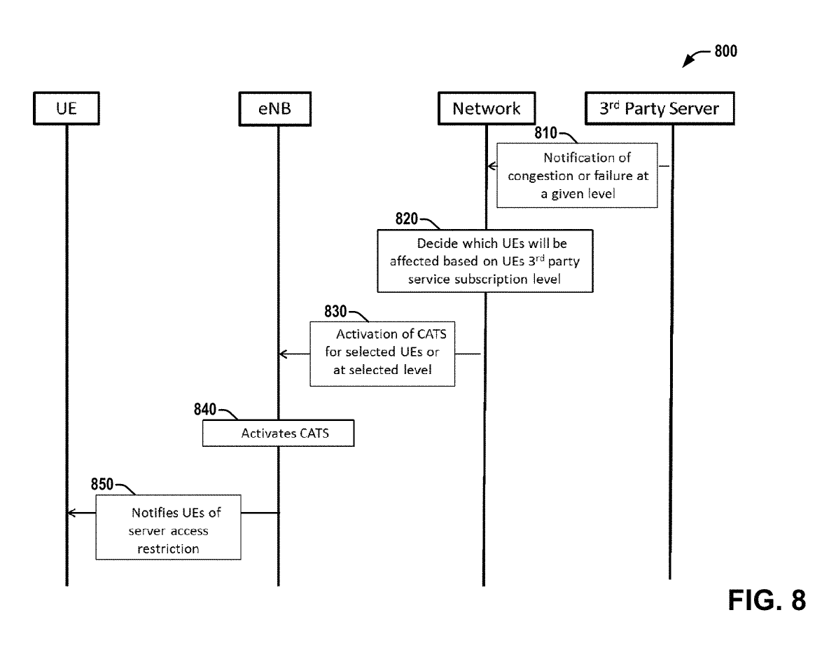

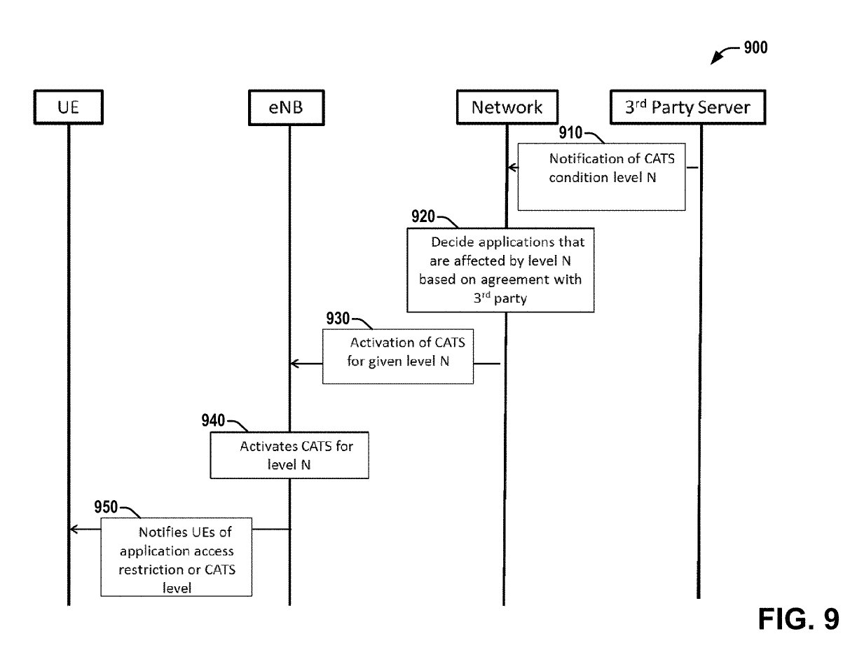

In a second example, new connection attempts can be prioritized based on one or more criteria pre-agreed upon by the third party application provider and the 3GPP operator. One such example is to prioritize using a subscriber class of the 3GPP network operator as a criterion, as explained in connection with table 1 and FIG. 7, under the prioritization options discussed infra. Another such example is to prioritize using a subscription class (e.g., paid vs. unpaid, etc.) with the third party application provider as explained in connection with table 2 and FIG. 8, under the prioritization options discussed infra. An additional example, in instances wherein the third party server or servers support multiple applications or functions, is to prioritize using applications or functions (individual applications or functions, groups thereof, etc.) as a criterion, as explained in connection with table 3 and FIG. 9, under the prioritization options discussed infra.

In a third example, traffic from UEs that have lower priorities (as discussed herein) can be restricted from connecting to the third party server, and in some aspects, when such UEs have connections, they can be disconnected when certain congestion or partial failure levels are determined.

In a fourth example, connections can be prioritized based at least in part on the amount of load that the UE generates in its connection to the third party server.

In a fifth example, connections can be prioritized based at least in part on the overall amount of load that the UE generates between all of its ongoing connections, for example, with all servers and other UEs.

In various aspects, combinations of more than one of the above examples or aspects thereof can be employed to alleviate congestion.

### Prioritization Options

Various prioritization options discussed herein can additionally be applied in non-CATS situations wherein a 3GPP operator and the third party application provider are not bound by net neutrality, and can apply different treatment to applications on their servers, UE and network in normal (e.g., non-emergency, etc.) situations.

In a first prioritization option, prioritization can be based on a 3GPP subscription level, as discussed above. Table 1, below, shows an example of access prioritization according to the 3GPP subscriber class of service:

TABLE 1
Example Prioritization of CATS Based on 3GPP Subscriber Class

| | | | 3GPP | 3GPP |
|---|---|---|---|---|
| | 3GPP Gold | 3GPP Silver | Bronze | Ordinary |
| | Subscriber | Subscriber | Subscriber | Subscriber |
| CATS level n: | Y | N | N | N |
| High Congestion | | | | |
| CATS level n + 1: | Y | Y | N | N |
| Medium Congestion | | | | |
| CATS level n + 2: | Y | Y | Y | N |
| Low Congestion | | | | |
| CATS Deactivated | Y | Y | Y | Y |

In table 1 above, ‘N’ indicates that traffic to the third party server will be restricted and ‘Y’ indicates that initiation of a connection to the third party server will not be restricted. The number (and names) of CATS levels and subscriber levels can vary from those indicated above, and can include substantially any number of CATS levels and/or subscription levels.

Referring to FIG. 7, illustrated is an example method 700 of implementing CATS with prioritization based on 3GPP subscription status according to various aspects described herein. Method 700 can include, at 710, the third party server notifying the 3GPP network of congestion or partial failure, which can optionally include a level of congestion or failure. Alternatively, the 3GPP network can determine the congestion or failure (and optionally an associated level) without being notified, using techniques discussed supra. At 720, the 3GPP network may determine which UEs will be affected, which can be based at least in part on 3GPP subscription level(s) of the UE(s). This determination can include determining a CATS level to implement based on the congestion or failure level. At 730, the 3GPP network can activate CATS for the determined UEs or determined CATS level (which may be associated with a set of UEs). At 740, CATS can be activated via eNB(s) serving one or more determined UEs (or UEs in the set of UEs associated with a determined CATS level). At 750, the eNB(s) of 740 can notify the determined UEs (or UEs in the set of UEs associated with the determined CATS level) of the server access restriction(s) associated with CATS. Optionally, CATS can be activated to all UEs registered in the PLMN network, removing the need for the network to determine which UEs will be affected. In this case, notification may be sent to all UEs

Depending on the specific embodiment, actions taken by the 3GPP network as discussed in method 700 and similar methods can include various network entities. For example, CATS activation can be initiated from: (1) the MME via the NAS protocol; (2) the ANDSF via the OMA-DM protocol; (3) a dedicated CATS server via HTTP protocol; (4) the RAN indicating CATS activation over radio channels (e.g., broadcast, multicast, dedicated channels, etc.); or other network entities.

One example implementation scenario of method 700 can be in connection with the example of table 1. For example, if the third party server is congested and (e.g., based on the agreement between the third party application provider and the 3GPP operator) CATS level n is determined, all traffic from the subscribing UEs will be restricted, with the exception of the 3GPP gold level (or some other arbitrary high level) subscribers.

As the congestion condition alleviates, the third party application server can notify the 3GPP Network of the improving condition. The Network can activate CATS level n+1, under which 3GPP gold and silver subscribers are not restricted in accessing the Server. In connection with example CATS level n+1, traffic from the 3GPP bronze and ordinary subscribers' UEs remain restricted from the third party server.

As the congestion condition further improves at the third party server, the 3GPP operator, based on the new congestion information, can activate CATS condition level n+2, wherein the traffic from the 3GPP bronze subscribers can be given the same treatment as the traffic from 3GPP gold and silver subscribers to the third party server. Traffic from the 3GPP ordinary subscribers to the third party server can still be restricted.

When the congestion level at the third party server completely subsides, CATS can be deactivated by the 3GPP operator, and all 3GPP subscribers that subscribe to the third party application can be allowed to connect without restrictions.

In a second prioritization option, prioritization can be based on a third party subscription level, as discussed above. In such aspects, there can be an agreement between the third party server and the 3GPP network operator to include the third party subscription level (e.g., service subscription level) of each device signed-up with the third party service. During congestion, the third party server can then identify which subscription level are restricted from accessing the service, and the third party server can send a notification to inform the 3GPP network. This notification can contain the third party subscription level(s) allowed to access the network or the third party subscription level(s) not allowed to access the network (e.g., a whitelist or a blacklist).

Table 2, below, shows an example of access prioritization according to the third party subscriber class of service with the third party application service provider:

TABLE 2
Example Prioritization of CATS Based on Third Party Subscriber Class

| | | 3^{rd} Party | 3^{rd} Party | 3^{rd} Party |
|---|---|---|---|---|
| | 3^{rd} Party Gold | Silver | Bronze | Ordinary |
| | Subscriber | Subscriber | Subscriber | Subscriber |
| CATS level n: | Y | N | N | N |
| High Congestion | | | | |
| CATS level n + 1: | Y | Y | N | N |
| Medium Congestion | | | | |
| CATS level n + 2: | Y | Y | Y | N |
| Low Congestion | | | | |
| CATS Deactivated | Y | Y | Y | Y |

In table 2 above, ‘N’ indicates that traffic to the third party server will be restricted and ‘Y’ indicates that initiation of a connection to the third party server will not be restricted. As with the first option, the number (and names) of CATS levels and subscriber levels can vary from those indicated above, and can include substantially any number of CATS levels and/or subscription levels.

Referring to FIG. 8, illustrated is an example method 800 of implementing CATS with prioritization based on a subscription status with a third party server according to various with aspects described herein. Method 800 can include, at 810, the third party server notifying the 3GPP network of congestion or partial failure, which can optionally include a level of congestion or failure. Alternatively, the 3GPP network can determine the congestion or failure (and optionally an associated level) without being notified, using techniques discussed supra. At 820, the 3GPP network can determine which UEs will be affected, which can be based at least in part on subscription level(s) of the UE(s) with the third party server. This determination can include determining a CATS level to implement based on the congestion or failure level. At 830, the 3GPP network can activate CATS for the determined UEs or determined CATS level (which can be associated with a set of UEs). At 840, CATS can be activated via eNB(s) serving one or more determined UEs (or UEs in the set of UEs associated with a determined CATS level). At 850, the eNB(s) of 840 can notify the determined UEs (or UEs in the set of UEs associated with the determined CATS level) of the server access restriction(s) associated with CATS.

In a third prioritization option, prioritization can be based on individual applications or functions associated with the third party server (or sets thereof), as discussed above. In aspects of this prioritization option, the 3GPP operator can activate different levels of CATS based on the congestion conditions at the third party server, thereby disallowing only the identified applications for condition level and allowing the rest of the applications on the black list (or vice versa, in connection with a white list).

The prioritization scheme can be achieved, for example, by assigning values allowed for each application on the list of applications. Optionally, the prioritization scheme can prioritize based on application types or categories, instead of via identifying specific applications. The values assigned can be numerical, alphabetical, textual, etc., or a combination thereof. Based on these values, applications can be allowed or not allowed to access the network. For example, for congestion of a given level (e.g., level n) at the third party server, the third party server can notify the 3GPP network and the 3GPP network can decide which applications should apply CATS. This decision can be based on an agreement between the 3GPP network operator and an entity running the third party server. The 3GPP network can then decide to trigger CATS for the given application(s). The network can then notify the UE of the CATS implementation. The notification can be done by informing the UE as to which application(s) are restricted or by telling the UE the server congestion level, and the UE can map the server congestion level to determine the application(s)) subject to CATS.

Table 3, below, shows an example of access prioritization based on applications or functions, offering different levels of granularity:

TABLE 3
Example Prioritization of CATS Based on Applications

| | App | App | App | App | App | App |
|---|---|---|---|---|---|---|
| | A | B | C | D | E | F |
| CATS Level n | N | N | N | N | N | N |
| CATS Level n + 1 | N | N | N | N | Y | Y |
| CATS Level n + 2 | N | N | Y | Y | Y | Y |
| CATS Deactivated | Y | Y | Y | Y | Y | Y |

In table 3 above, ‘N’ indicates that traffic to the third party server will be restricted and ‘Y’ indicates that traffic to the third party server will not be restricted. As with the above options, CATS levels can vary from those indicated above, and can include substantially any number of CATS levels. Although table 3 lists example applications, sets or categories of applications, functions, or combinations thereof can additionally or alternatively be designated in connection with CATS levels.

Referring to FIG. 9, illustrated is an example method 900 of implementing CATS with prioritization based on applications or functions according to various aspects described herein. Method 900 can include, at 910, the third party server notifying the 3GPP network of congestion or partial failure, which can include a CATS level or designate one or more applications or functions for CATS. Alternatively, the 3GPP network can determine a CATS level without being notified, using techniques discussed supra. At 920, the 3GPP network can determine which applications and/or functions will be affected, which can be based on the CATS level or indicated applications and/or functions. At 930, the 3GPP network can activate CATS for the determined applications/functions or determined CATS level (which can be associated with a set of applications and/or functions). At 940, CATS can be activated via eNB(s) serving one or more UEs subscribing to the determined applications/functions. At 950, the eNB(s) of 940 can notify the subscribing UEs of the server access restriction(s) associated with CATS.

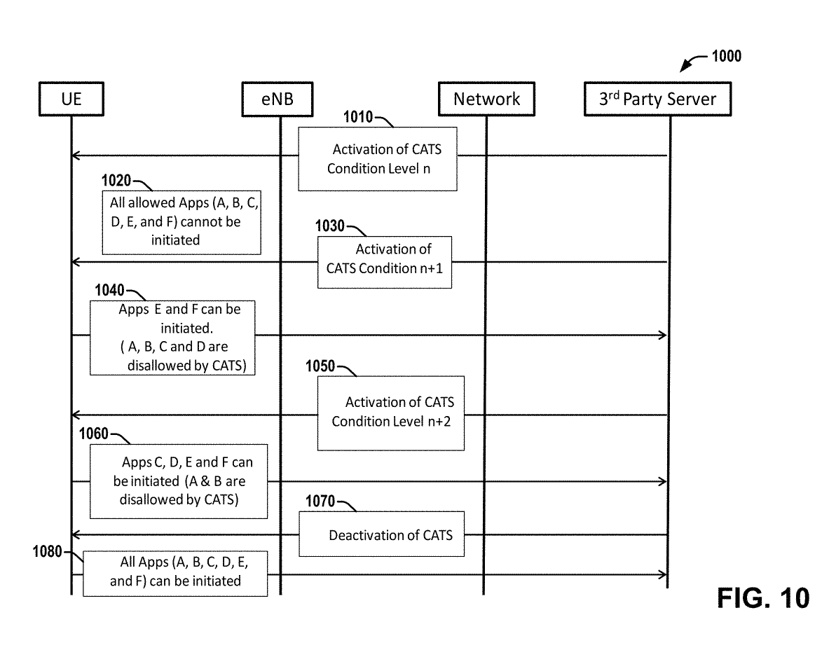

Referring to FIG. 10, illustrated is an example method 1000 of third party implementation of CATS with prioritization based on applications or functions according to various aspects described herein. Method 1000 can include, at 1010, activation of CATS at a first selected level (e.g., level n in table 3) by a third party server, such as based on a detected congestion or failure. At 1020, in accordance with the first selected CATS level, a set of applications and/or functions can be restricted; for example, as with example CATS level n in table 3, all applications are restricted. At 1030, as a detected congestion or failure level improves, a second selected level of CATS (e.g., level n+1 in table 3), can be activated by the third party server, and at 1040, a first set of applications and/or functions can be allowed while a second set of applications and/or functions can remain restricted. For example, as in table 3, applications E and F can be allowed, and applications A, B, C, and D can be restricted. At 1050, as a detected congestion or failure level further improves, a third selected level of CATS (e.g., level n+2 in table 3), can be activated by the third party server, and at 1060, a third set of applications and/or functions can be allowed while a fourth set of applications and/or functions can remain restricted. For example, as in table 3, applications C, D, E, and F can be allowed, and applications A and B can be restricted. At 1070, upon cessation of the detected congestion or failure, CATS can be deactivated by the third party server, and at 1080, all applications and/or functions can be allowed.

As used herein (e.g., in connection with FIGS. 7, 8, 9, and 10, etc.), the term Network can include any of a variety of components that can facilitate or activate CATS. The activation of CATS conditions in a UE can be initiated from, for example, the MME via the NAS protocol, the ANDSF via the OMA-DM protocol, a dedicated CATS server via HTTP protocol, the RAN indicating CATS activation over radio channels (e.g., broadcast, multicast, or dedicated channels), etc.

### Notification of CATS Activation to UEs

In the case of a complete failure at the third party server, the 3GPP network can detect the failure, can activate CATS, and can prevent further attempts to access the failed third party server, as explained in greater detail supra. In various aspects, the 3GPP network can disconnect the connections that UEs have with the third party server, as well.

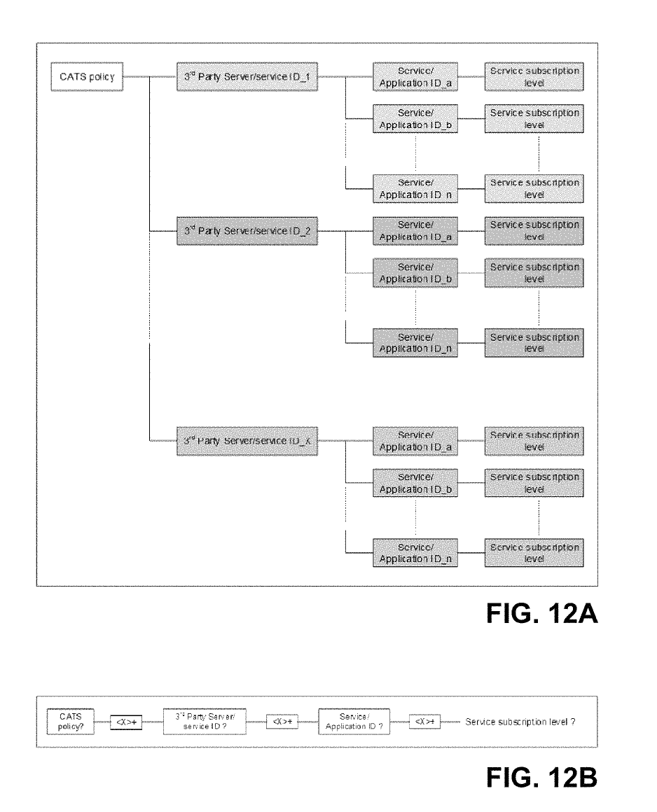

The notification to the UEs can be sent via at least one of: (a) a paging channel, (b) dedicated messages (e.g, NAS signaling as explained in greater detail infra in connection with FIGS. 12A and 12B), (c) multicast and/or broadcast channels, or (d) OMA-DM configuration (as discussed in greater detail below, such as in connection with FIGS. 12A and 12B) that can be followed by a message to the UE via any of options a, b, or c.

The notifications can be sent both to idle mode and connected mode UEs. This notification can be included as new information elements (lEs) or structures as part of current messages or as new messages that can be created. In addition, existing functionality defined in 3GPP can be re-used and extended its functionality to also notify UEs of CATS.

If a UE is already connected to the server and there is a failure of the connection, when trying to reconnect the UE can be required to comply with the CATS rule, if applicable (e.g., if CATS applies to that UE and attempted application/function).

### Management, Provision and Manipulation of CATS Grade of Subscriber/Subscription

Further techniques for management, provision and manipulation of a UE's CATS third party subscription level/grade of service can include the use of NAS signaling, OMA-DM signaling, subscriber identity module (SIM) Toolkit, or over the top signaling.

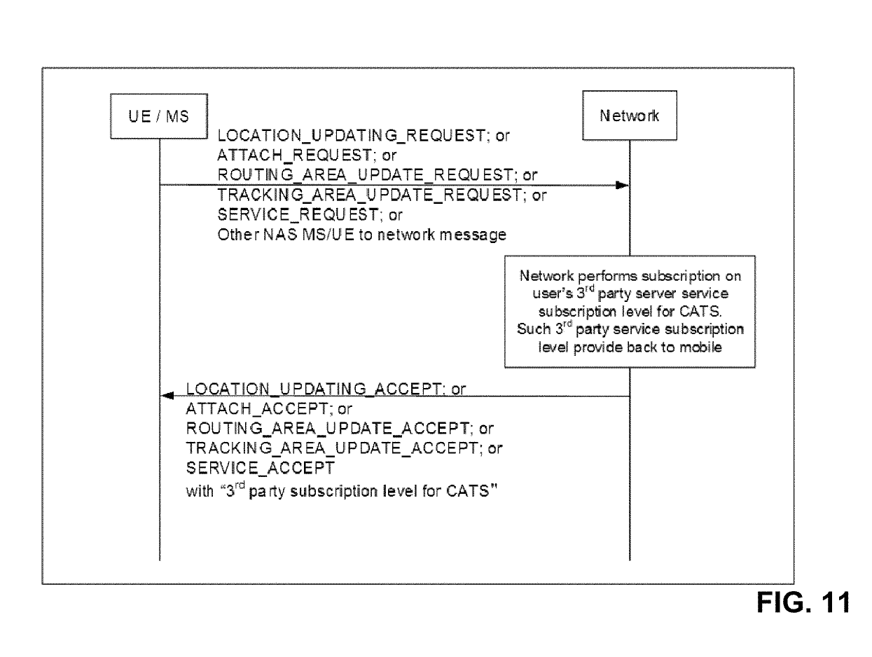

In one example, NAS signaling can be employed for management, provision, and/or manipulation of subscription levels and/or grades of service. For example, an indication of a UE's third party subscription level can be used when CATS is active to ascertain if a request for service from a third party is allowed when CATS is active, and can be signaled to the UE by the network through NAS signaling messages such as those described in connection with 3GPP technical specifications (TSs) 24.008 and 24.301. FIG. 11 illustrates an example implementation of NAS signaling for communication of subscription level information in connection with CATS according to various aspects described herein.

In another example, OMA-DM signaling can be employed. Under the auspices of the OMA (Open Mobile Alliance), means have been standardized for provisioning information to a UE from sources within an operator's 3GPP network or from organizations or companies authorized by the Operator's 3GPP network. OMA has enabled this through protocol mechanisms defined in OMA Device Management (DM) protocol specifications, version 1.2. Using these OMA mechanisms, a UE can be provisioned with information associated with CATS policies, as well as information about individual third party servers, their applications and the subscription level(s) associated with the UE. FIG. 12A illustrates an example of an OMA-DM data structure providing information regarding a CATS policy according to various aspects described herein. FIG. 12B illustrates a representation of the example OMA-DM data structure of FIG. 12A as part of an OMA Management Object representation according to various aspects described herein.

In connection with the example data structure shown in FIGS. 12A-12B (or similar data structures), a UE can be informed of the specific service subscription level(s) of the service(s) or application(s) that a certain third party server is hosting. The subscription level(s) can include substantially any number of levels (or, alternatively, any number up to a maximum number of allowed levels), such as defined by the third party server, and can be associated with whether or not access is restricted for UEs associated with that subscription level at each of one or more CATS levels. In one example, subscription levels can be the example subscription levels shown in tables 1 and 2 (e.g., gold, silver, bronze, ordinary). Alternatively, subscription levels can just indicate premium level, ordinary level, or entry level, etc. In connection with some third party servers, subscription level information can be associated with or determined from other aspects of a relationship with a third party server (e.g., based on how much money a user has in an investment or trading account, as compared with one or more threshold values that define cutoff values for various subscription levels, etc.).

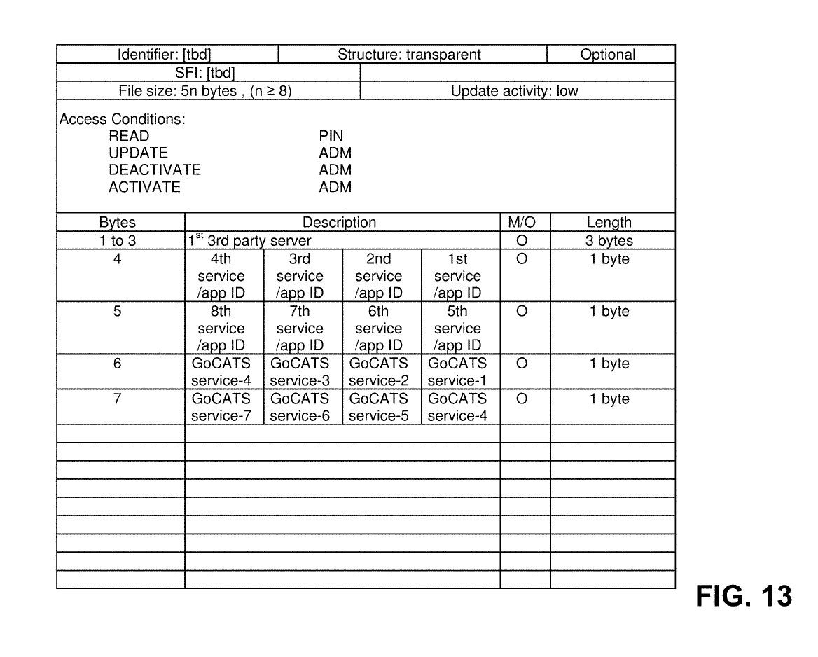

In a third example, the SIM toolkit can be employed. In such aspects, an EF (Elementary File) can be stored in the universal SIM (USIM), similar to the EFs defined in 3GPP TS 31.102. This EF is referred to herein as EF_{CATS}. Via the SIM Toolkit, provisioning and updating of EF_{CATS} can populate and update information about subscription level to which the UE is subscribed for indicated third party servers. FIG. 13 illustrates an example EF_{CATS} with example contents according to various aspects described herein.

The example EF_{CATS} of FIG. 13 includes an indication of the third party server/service. Following that, the service/application IDs that can be subject to CATS are indicated. In the example of FIG. 13, up to 8 types of service/application ID for the third party server/service is shown. Following this, for each of the indicated service/application IDs, there is a corresponding indication of the subscribed Grade of CATS service (GoCATSservice). In the example of FIG. 13, GoCATSservice-1 can be related to the first service/app-ID and GoCATSservice-2 can be related to the second service/application-ID, etc. Furthermore, in this example, GoCATSservice is a 2 bit indication which can be used to indicate up to four levels or grades, e.g., gold subscription, silver subscription, bronze subscription, or ordinary subscription.

In the example EF_{CATS} of FIG. 13, only one set of information for one third party server is shown. However, any number of additional sets of information for additional third party servers can be provided in such an EF_{CATS} file. However, if the EF_{CATS} file becomes exceedingly large, there will be an effect on total USIM space taken and the speed and time taken when manipulations have to be performed on EF_{CATS}.

Additionally, although the example EF_{CATS} of FIG. 13 contains fields for up to eight applications in the set of information for a third party server, in various aspects, a greater or lesser number of applications can be indicated, or certain third party servers can have multiple entries for situations wherein the number of applications exceeds the allotment associated with a single entry.

By configuring an EF such as the example EF_{CATS} of FIG. 13, CATS-related information useable by the UE in managing starting of applications when the network indicates CATS is active can be provided to the mobile. Provision and manipulation of the EF can be accomplished via the SIM toolkit defined in 3GPP TSs 22.038 and 31.111.

In a fourth example, over the top signaling can be employed, such as via non-3GPP access methods defined in TS 24.302, through IP level signaling. Over the top signaling means that pertinent data is transferred from one peer to another peer (or vice-versa) without the underlying or bearer network aware of the data signaled.

Over the years, the 3GPP network has provided data services, and today UEs connected to the 3GPP cellular systems can be used to access the internet in the same way as a desktop computer hooked to a fixed telephone or cable line. In over the top signaling aspects, once a UE is connected for data services, the CATS server node and/or CATS subsystem can provide CATS related data to the UE through IP (Internet Protocol) signaling. In FIG. 5, the dashed line between the UE and the third party server represents optional over the top signaling aspects.

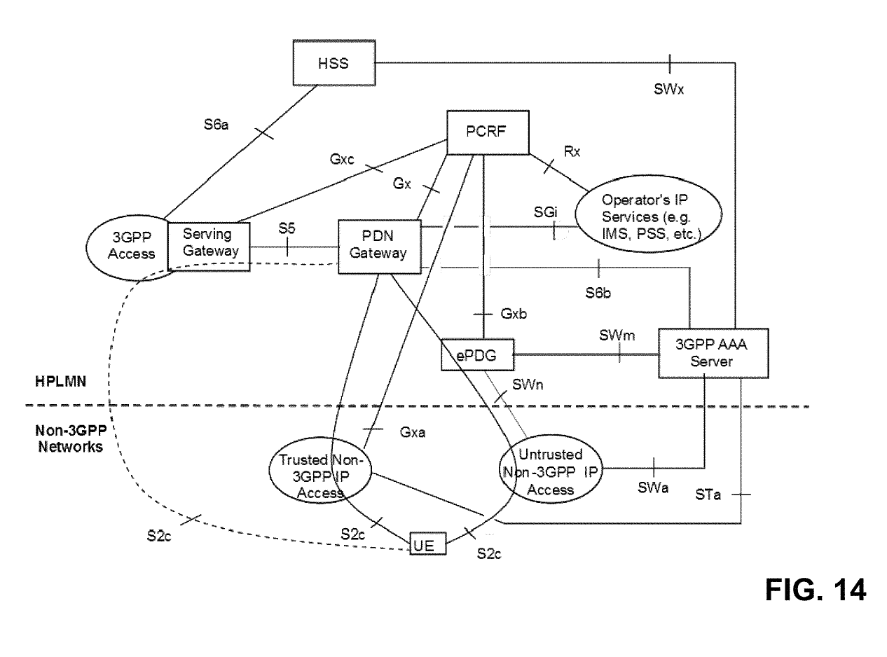

Yet another technique of over the top signaling of CATS related information can be to signal over the non-3GPP access network. FIG. 14 illustrates an example architecture useable for over the top signaling of CATS information, providing access to the 3GPP's PDN (Packet Data Network) Gateway through the non-3GPP access networks according to various aspects described herein. FIG. 14 corresponds to FIG. 4.2.2-2 of 3GPP TS 23.402. TS 23.402 gives the architecture enhancements of the 3GPP system to allow access by UEs through non-3GPP access networks—comprising, for example, trusted or untrusted WLAN, WiMAX, or CDMA2000—with TS 24.302 defining the Stage 3 signaling and protocol details for such access.

UEs are increasingly able to actively communicate over more than just one means of access. For example, a UE can be registered to a 3GPP PLMN (public land mobile network)/Operator while simultaneously in active communication over WiFi or WLAN, for example, accessing the internet. In fact more and more of today's 3GPP operators are deploying their own WiFi/WLAN networks, and via the designs, signaling, and protocols of TS 24.302, allowing UEs to gain access to the core 3GPP networks through both 3GPP cellular access and non-3GPP/WLAN access.

As the same UE can now have a connection to the 3GPP core network—and in particular to the 3GPP's PGW (PDN Gateway), at the user end of the UE or at the level of running applications in communications with their peers at some remote server, the CATS information can be delivered over the top to the UE over non-3GPP access.

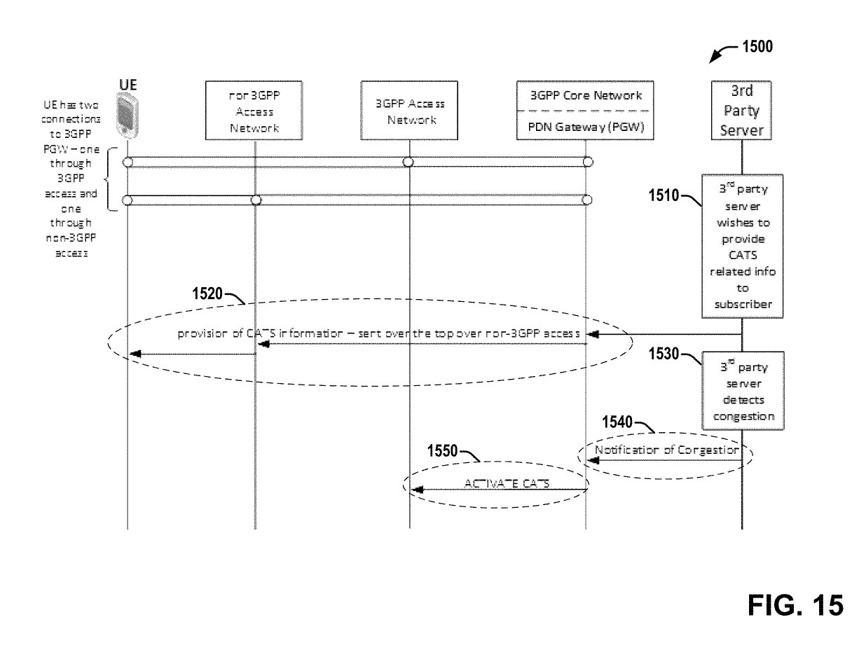

Referring to FIG. 15, illustrated is an example method 1500 of implementing CATS via over the top signaling according to various aspects described herein. Method 1500 can include, at 1510, the third party server making a determination to send CATS-related information to a UE. At 1520, the CATS-related information can be provided to the UE over the top through non-3GPP access. At 1530, the third party server can detect congestion or failure associated with the third party server, and at 1540, can notify the 3GPP core network of the congestion or failure, such as via the PGW. At 1550, in response to the notification of congestion or failure, the 3GPP can activate CATS via the 3GPP access network.

### Activation/Deactivation of CATS

In addition to methods of activation or deactivation of CATS discussed supra, NAS signaling can be applied.

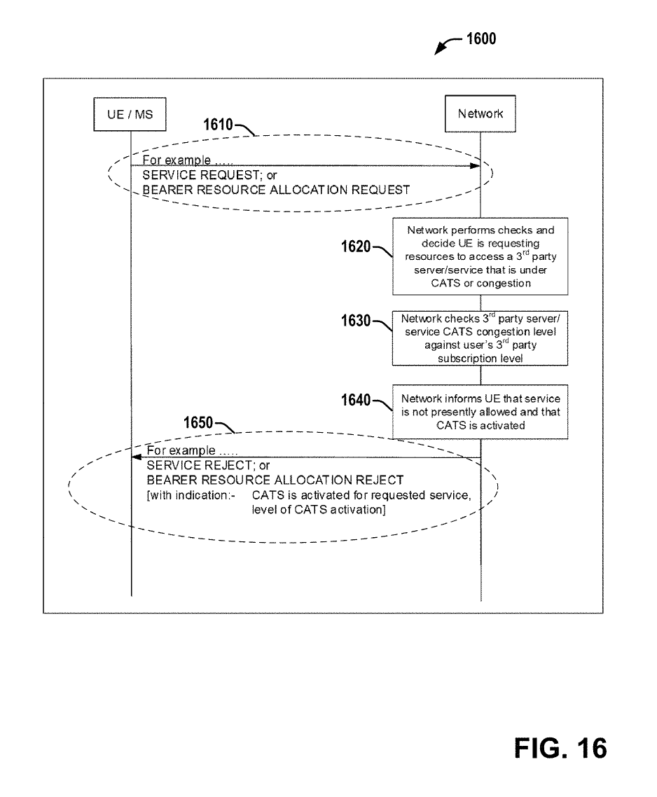

The NAS messages discussed in TSs 24.008 and 24.301, exchanged between the network and UE, can be employed to carry an indication to activate or deactivate CATS for affected UEs. FIG. 16 illustrates an example method 1600 of using NAS messages to activate CATS according to various aspects described herein. Method 1600 can include, at 1610, a UE generating a request for resources to access a third party server. At 1620, the network can determine if the third party server is subject to CATS. Upon determining that the third party server is subject to CATS, at 1630, the network can determine whether the CATS restriction applies to the requesting UE, for example, based on a third party or 3GPP subscription level of the UE. At 1640, the network can inform the UE that the requested service is not available, and that CATS is activated. As indicated at 1650, the network can reject the UE request via an NAS signal indicating that CATS is activated and a level of CATS activation.

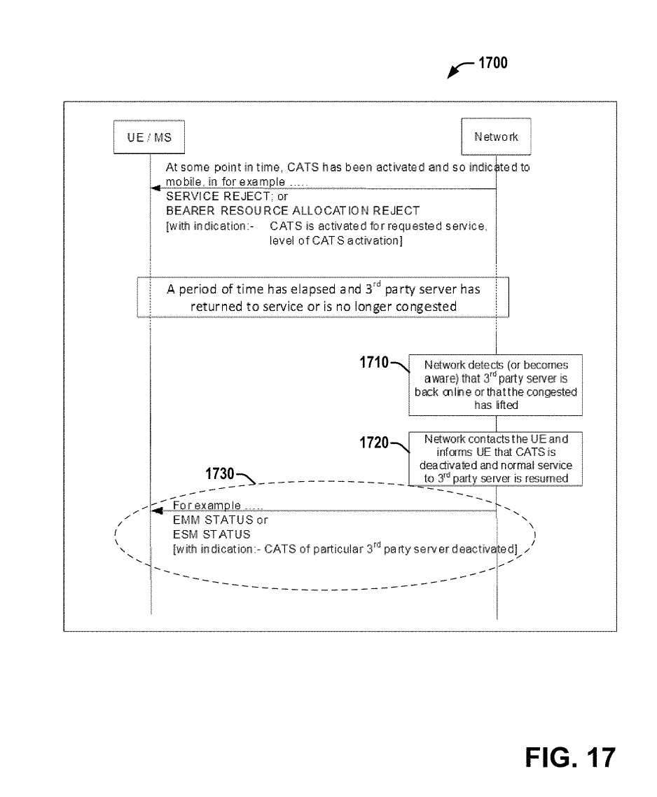

The deactivation of CATS can also be conveyed to a UE via NAS messages. FIG. 17 illustrates an example method 1700 of using NAS messages to deactivate CATS according to various aspects described herein. Although specific example TS 24.301 NAS messages are shown in FIG. 17, in various aspects any appropriate NAS messages from TSs 24.301 or 24.008 could be used. Method 1700 can be applied in situations wherein a third party server for which CATS has been activated no longer requires CATS, for example, because service has been restored or congestion has diminished. At 1710, the network can receive an indication from the third party server or can detect that the failure or congestion that previously caused CATS to be implemented no longer applies. At 1720, the network can inform the UE that normal service to the third party server has been restored, and that CATS is deactivated. As indicated at 1730, the network can notify the UE via an NAS signal indicating that CATS has been deactivated for that particular third party server.

### Additional Aspects

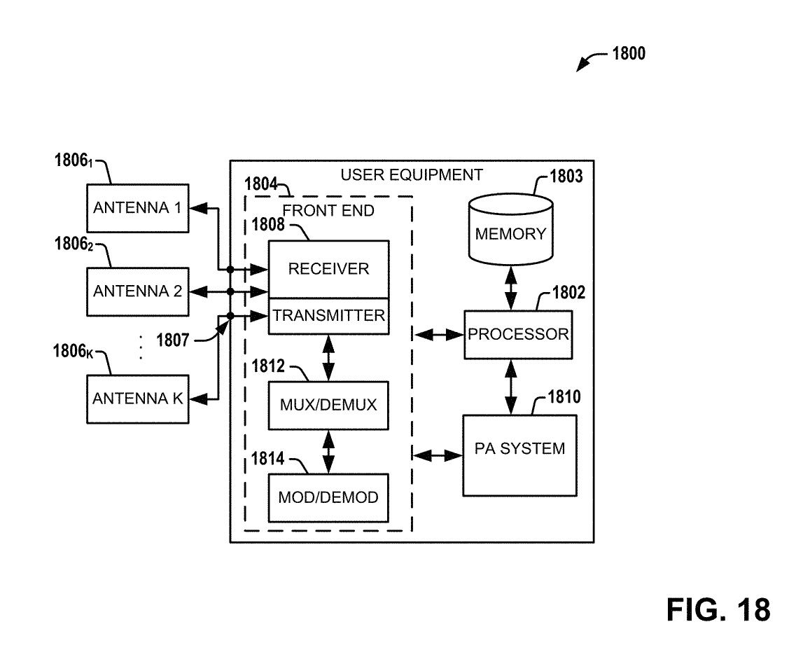

Referring to FIG. 18, illustrated is an exemplary user equipment or mobile communication device 1800 that can be utilized with one or more aspects of the systems, methods, or devices facilitating communication with aggregation of downlink component carrier described herein according to various aspects. The user equipment 1800, for example, comprises a digital baseband processor 1802 that can be coupled to a data store or memory 1803, a front end 1804 (e.g., an RF front end, an acoustic front end, or the other like front end) and a plurality of antenna ports 1807 for connecting to a plurality of antennas 1806₁ to 1806ₖ (k being a positive integer). The antennas 1806₁ to 1806ₖ can receive and transmit signals to and from one or more wireless devices such as access points, access terminals, wireless ports, routers and so forth, which can operate within a radio access network or other communication network generated via a network device. The user equipment 1800 can be a radio frequency (RF) device for communicating RF signals, an acoustic device for communicating acoustic signals, or any other signal communication device, such as a computer, a personal digital assistant, a mobile phone or smart phone, a tablet PC, a modem, a notebook, a router, a switch, a repeater, a PC, network device, base station or a like device that can operate to communicate with a network or other device according to one or more different communication protocols or standards.

The front end 1804 can include a communication platform, which comprises electronic components and associated circuitry that provide for processing, manipulation or shaping of the received or transmitted signals via one or more receivers or transmitters 1808, a mux/demux component 1812, and a mod/demod component 1814. The front end 1804, for example, is coupled to the digital baseband processor 1802 and the set of antenna ports 1807, in which the set of antennas 1806₁ to 1806ₖ can be part of the front end.

The user equipment 1800 can also include a processor 1802 or a controller that can operate to provide or control one or more components of the user equipment 1800. For example, the processor 1802 can confer functionality, at least in part, to substantially any electronic component within the user equipment 1800, in accordance with aspects of the disclosure. As an example, the processor 1802 can be configured to execute, at least in part, executable instructions that facilitate generation of an aperiodic CSI report in situations involving carrier aggregation of more than five serving cells, in accordance with aspects described herein.

The processor 1802 can operate to enable the user equipment 1800 to process data (e.g., symbols, bits, or chips) for multiplexing/demultiplexing with the mux/demux component 1812, or modulation/demodulation via the mod/demod component 1814, such as implementing direct and inverse fast Fourier transforms, selection of modulation rates, selection of data packet formats, inter-packet times, etc. Memory 1803 can store data structures (e.g., metadata), code structure(s) (e.g., modules, objects, classes, procedures, or the like) or instructions, network or device information such as policies and specifications, attachment protocols, code sequences for scrambling, spreading and pilot (e.g., reference signal(s)) transmission, frequency offsets, cell IDs, and other data for detecting and identifying various characteristics related to RF input signals, a power output or other signal components during power generation.

The processor 1802 is functionally and/or communicatively coupled (e.g., through a memory bus) to memory 1803 in order to store or retrieve information necessary to operate and confer functionality, at least in part, to communication platform or front end 1804 including the receiver 1808, and the power amplifier (PA) system 1810. While the components in FIG. 18 are illustrated in the context of a user equipment, such illustration is not limited to user equipment but also extends to other wireless communication devices, such as base station (e.g., eNodeB), small cell, femtocell, macro cell, microcell, etc.

Examples herein can include subject matter such as a method, means for performing acts or blocks of the method, at least one machine-readable medium including executable instructions that, when performed by a machine (e.g., a processor with memory or the like) cause the machine to perform acts of the method or of an apparatus or system for concurrent communication using multiple communication technologies according to embodiments and examples described.

Example 1 is a network server that facilitates Control of one or more Applications when Third party Servers encounter difficulties (CATS), comprising a processor and an interface. The processor is configured to determine a status associated with a third party server; determine a network load level of a network associated with the network server; select a CATS level for the third party server based at least in part on the status associated with the third party server and the network load level, wherein the CATS level defines one or more restrictions on network traffic associated with the third party server; and implement the one or more restrictions on network traffic toward the third party server. The interface is configured to transmit an indicator of the CATS level for the third party server.

Example 2 includes the subject matter of example 1, wherein the processor being configured to implement the one or more restrictions on network traffic toward the third party server comprises the processor being configured to prevent an attempted packet data network (PDN) connection between a first user equipment (UE) and the third party server based at least in part on the CATS level.

Example 3 includes the subject matter of example 1, wherein the one or more restrictions comprise at least one restriction based on a user equipment (UE) subscription status with an operator of the network server.

Example 4 includes the subject matter of example 1, wherein the one or more restrictions comprise at least one restriction based on a subscription status with an operator of the third party server.

Example 5 includes the subject matter of example 1, wherein the one or more restrictions comprise at least one restriction associated with a first application or a first function of the third party server.

Example 6 includes the subject matter of example 1, wherein the one or more restrictions comprise at least one restriction associated with a current amount of network traffic over an existing packet data network (PDN) connection with the third party server.

Example 7 includes the subject matter of example 1, wherein the one or more restrictions comprise at least one restriction associated with a current aggregate amount of network traffic associated with a user equipment (UE).

Example 8 includes the subject matter of any variation of examples 1-7, including or omitting optional features, wherein the processor is further configured to disconnect at least one existing packet data network (PDN) connection with the third party server based at least in part on the one or more restrictions.

Example 9 includes the subject matter of example 1, wherein the network server is collocated with a mobile management entity (MME), and wherein the transmitter circuit is configured to transmit the indicator of the CATS level via a non-access stratum.

Example 10 includes the subject matter of example 1, wherein the network server is collocated with a access network discovery and selection function (ANDSF), and wherein the transmitter circuit is configured to transmit the indicator of the CATS level via an Open Mobile Alliance (OMA) Device Management (DM) protocol.

Example 11 includes the subject matter of any variation of examples 1-8, including or omitting optional features, wherein the network server is collocated with a mobile management entity (MME), and wherein the transmitter circuit is configured to transmit the indicator of the CATS level via a non-access stratum.

Example 12 includes the subject matter of any variation of examples 1-8, including or omitting optional features, wherein the network server is collocated with a access network discovery and selection function (ANDSF), and wherein the transmitter circuit is configured to transmit the indicator of the CATS level via an Open Mobile Alliance (OMA) Device Management (DM) protocol.

Example 13 is a non-transitory machine readable medium comprising instructions that, when executed, cause at least one server to: determine a status of a third party server; select a level of Control of one or more Applications when Third party Servers encounter difficulties (CATS) based at least in part on the status of the third party server; and transmit an indication of the level of CATS, wherein the level of CATS defines one or more restrictions on network traffic toward the third party server, wherein at least one of the one or more restrictions is based on a subscription status.

Example 14 includes the subject matter of example 13, wherein the instructions, when executed, cause the at least one server to determine the status of the third party server based at least in part on an absence of successful connection attempts with the third party server for at least a threshold period of time.

Example 15 includes the subject matter of example 13, wherein the instructions, when executed, cause the at least one server to determine the status of the third party server based at least in part on congestion data received from the third party server.

Example 16 includes the subject matter of example 13, wherein the instructions, when executed, cause the at least one server to determine the status of the third party server based at least in part on a number of rejected connection attempts with the third party server during a predetermined period of time.

Example 17 includes the subject matter of example 13, wherein the instructions, when executed, cause the at least one server to determine the status of the third party server based at least in part on a number of consecutive rejected connection attempts with the third party server exceeding a threshold number.

Example 18 includes the subject matter of example 13, at least one restriction on network traffic toward the third party server identifies at least one restricted content type, wherein the at least one restricted content type comprises at least one of a video content, an audio content, or an image content.

Example 19 includes the subject matter of any variation of examples 13-18, including or omitting optional features, at least one restriction on network traffic toward the third party server identifies at least one restricted service associated with the third party server.

Example 20 includes the subject matter of example 13, wherein the instructions, when executed, cause the server to prevent at least one attempted packet data network (PDN) connection with the third party server based at least in part on the one or more restriction.

Example 21 is a user equipment (UE) that facilitates Control of one or more Applications when Third party Servers encounter difficulties (CATS), comprising a receiver circuit and a processor. The receiver circuit is configured to receive an indication of a CATS level associated with at least one third party server, wherein the CATS level is associated with at least one restriction on network traffic between the UE and the third party server. The processor is operably coupled to the receiver circuit and configured to identify one or more applications associated with the at least one third party server based at least in part on the indication; and at least one of delay or prevent at least one transmission associated with at least one of the one or more applications based on the at least one restriction.

Example 22 includes the subject matter of example 21, wherein the indication of the CATS level is received via at least one of a non-access spectrum (NAS) signal or a radio resource control (RRC) signal.

Example 23 includes the subject matter of any variation of examples 21-22, including or omitting optional features, wherein the CATS level is associated with a subscription level of the UE with a radio access network (RAN).

Example 24 includes the subject matter of example 21, wherein the CATS level is associated with a subscription level of the UE with the third party server.

Example 25 includes the subject matter of example 24, wherein the subscription level is stored by the UE in a universal subscriber identity module (USIM) elementary file (EF).

Example 26 includes the subject matter of example 21, wherein the indication of the CATS level is received via a paging channel.

Example 27 includes the subject matter of example 21, wherein the indication of the CATS level is received via at least one of a broadcast transmission or a multicast transmission.

Example 28 is a network server that facilitates Control of one or more Applications when Third party Servers encounter difficulties (CATS), comprising means for processing and means for transmitting. The means for processing is configured to determine a status associated with a third party server; determine a network load level of a network associated with the network server; select a CATS level for the third party server based at least in part on the status associated with the third party server and the network load level, wherein the CATS level defines one or more restrictions on network traffic associated with the third party server; and implement the one or more restrictions on network traffic toward the third party server. The means for transmitting is configured to transmit an indicator of the CATS level for the third party server.

Example 29 is a user equipment (UE) that facilitates Control of one or more Applications when Third party Servers encounter difficulties (CATS), comprising means for receiving and means for processing. The means for receiving is configured to receive an indication of a CATS level associated with at least one third party server, wherein the CATS level is associated with at least one restriction on network traffic between the UE and the third party server. The means for processing is operably coupled to the means for receiving and configured to identify one or more applications associated with the at least one third party server based at least in part on the indication; and at least one of delay or prevent at least one transmission associated with at least one of the one or more applications based on the at least one restriction.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature can be combined with one or more other features of the other implementations as may be desired and advantageous for any given or particular application.

1. A network server that facilitates Control of one or more Applications when Third party Servers encounter difficulties (CATS), comprising:
a processor configured to:
determine a status associated with a third party server;
determine a network load level of a network associated with the network server;
select a CATS level for the third party server based at least in part on the status associated with the third party server and the network load level, wherein the CATS level defines one or more restrictions on network traffic associated with the third party server; and
implement the one or more restrictions on network traffic toward the third party server; and
an interface configured to transmit an indicator of the CATS level for the third party server.

2. The network server of claim 1, wherein the processor being configured to implement the one or more restrictions on network traffic toward the third party server comprises the processor being configured to prevent an attempted packet data network (PDN) connection between a first user equipment (UE) and the third party server based at least in part on the CATS level.

3. The network server of claim 1, wherein the one or more restrictions comprise at least one restriction based on a user equipment (UE) subscription status with an operator of the network server.

4. The network server of claim 1, wherein the one or more restrictions comprise at least one restriction based on a subscription status with an operator of the third party server.

5. The network server of claim 1, wherein the one or more restrictions comprise at least one restriction associated with a first application or a first function of the third party server.

6. The network server of claim 1, wherein the one or more restrictions comprise at least one restriction associated with a current amount of network traffic over an existing packet data network (PDN) connection with the third party server.

7. The network server of claim 1, wherein the one or more restrictions comprise at least one restriction associated with a current aggregate amount of network traffic associated with a user equipment (UE).

8. The network server of claim 1, wherein the processor is further configured to disconnect at least one existing packet data network (PDN) connection with the third party server based at least in part on the one or more restrictions.

9. The network server of claim 1, wherein the network server is collocated with a mobile management entity (MME), and wherein the transmitter circuit is configured to transmit the indicator of the CATS level via a non-access stratum.

10. The network server of claim 1, wherein the network server is collocated with a access network discovery and selection function (ANDSF), and wherein the transmitter circuit is configured to transmit the indicator of the CATS level via an Open Mobile Alliance (OMA) Device Management (DM) protocol.

11. A non-transitory machine readable medium comprising instructions that, when executed, cause at least one server to:
determine a status of a third party server;
select a level of Control of one or more Applications when Third party Servers encounter difficulties (CATS) based at least in part on the status of the third party server; and
transmit an indication of the level of CATS, wherein the level of CATS defines one or more restrictions on network traffic toward the third party server, wherein at least one of the one or more restrictions is based on a subscription status.

12. The non-transitory machine readable medium of claim 11, wherein the instructions, when executed, cause the at least one server to determine the status of the third party server based at least in part on an absence of successful connection attempts with the third party server for at least a threshold period of time.

13. The non-transitory machine readable medium of claim 11, wherein the instructions, when executed, cause the at least one server to determine the status of the third party server based at least in part on congestion data received from the third party server.

14. The non-transitory machine readable medium of claim 11, wherein the instructions, when executed, cause the at least one server to determine the status of the third party server based at least in part on a number of rejected connection attempts with the third party server during a predetermined period of time.

15. The non-transitory machine readable medium of claim 11, wherein the instructions, when executed, cause the at least one server to determine the status of the third party server based at least in part on a number of consecutive rejected connection attempts with the third party server exceeding a threshold number.

16. The non-transitory machine readable medium of claim 11, at least one restriction on network traffic toward the third party server identifies at least one restricted content type, wherein the at least one restricted content type comprises at least one of a video content, an audio content, or an image content.

17. The non-transitory machine readable medium of claim 11, at least one restriction on network traffic toward the third party server identifies at least one restricted service associated with the third party server.

18. The non-transitory machine readable medium of claim 11, wherein the instructions, when executed, cause the server to prevent at least one attempted packet data network (PDN) connection with the third party server based at least in part on the one or more restriction.

19. A user equipment (UE) that facilitates Control of one or more Applications when Third party Servers encounter difficulties (CATS), comprising:
a receiver circuit configured to receive an indication of a CATS level associated with at least one third party server, wherein the CATS level is associated with at least one restriction on network traffic between the UE and the third party server;
a processor operably coupled to the receiver circuit and configured to:
identify one or more applications associated with the at least one third party server based at least in part on the indication; and
at least one of delay or prevent at least one transmission associated with at least one of the one or more applications based on the at least one restriction.

20. The UE of claim 19, wherein the indication of the CATS level is received via at least one of a non-access spectrum (NAS) signal or a radio resource control (RRC) signal.

21. The UE of claim 19, wherein the CATS level is associated with a subscription level of the UE with a radio access network (RAN).

22. The UE of claim 19, wherein the CATS level is associated with a subscription level of the UE with the third party server.

23. The UE of claim 22, wherein the subscription level is stored by the UE in a universal subscriber identity module (USIM) elementary file (EF).

24. The UE of claim 19, wherein the indication of the CATS level is received via a paging channel.

25. The UE of claim 19, wherein the indication of the CATS level is received via at least one of a broadcast transmission or a multicast transmission.
